(19) United States
(12) Patent Application Publication
(10) Pub. No.: US 2025/0104302 A1
(43) Pub. Date: Mar. 27, 2025

(54) SYSTEMS AND METHODS FOR SETTING PRICE POINTS

(71) Applicants: Robin Antonick, Portland, OR (US); Ryan Antonick, Waukesha, WI (US)

(72) Inventors: Robin Antonick, Portland, OR (US); Ryan Antonick, Waukesha, WI (US)

(21) Appl. No.: 18/894,610

(22) Filed: Sep. 24, 2024

Related U.S. Application Data
(63) Continuation of application No. PCT/US2024/047587, filed on Sep. 20, 2024.
(60) Provisional application No. 63/584,321, filed on Sep. 21, 2023.
(60) Provisional application No. 63/696,796, filed on Sep. 19, 2024.

(51) Int. Cl. G06T 11/20; G06Q 30/0283

(52) U.S. Cl. CPC G06T 11/206; G06Q 30/0283

(57) ABSTRACT

A system for setting price points for a sale product includes a data collection server that is configured to collect data from display systems of a sale product and third party providers of the sale product. A middleware server is configured to analyze and sort the data to generate a visualization of the data. A model server is configured to tune the visualization of the data and reduce artificial intelligence hallucinations occurring in the visualization of the data and recommendations derived from the digestion of the data. A display platform displays the visualization of the data with an interactive environment for data driven, machine learning informed query and insight for decision making.

### CROSS-REFERENCE TO RELATED APPLICATIONS

This application claims priority to International Patent Application No. PCT/US2024/047587, filed Sep. 20, 2024, which claims priority to U.S. Provisional Application No. 63/584,321, filed Sep. 21, 2023, and U.S. Provisional Application No. 63/696,796, filed Sep. 19, 2024, all of which are expressly incorporated by reference herein.

### BACKGROUND

The present disclosure relates to systems and methods for setting price points and, more particularly, to setting price points for vehicle sales.

Products offered in marketplaces must be seen to be sold. Generally, many products are listed online on display systems for related products and on third party provider websites. For example, Autotrader®, CarGurus®, Carfax®, and Cars.com® are the leading display systems for vehicles. Poor pivot price point rankings impact buyer visibility. Dealers, who ultimately set prices, are unaware of these pivot price point rankings and their impact on buyer visibility, sales and profit. For example, cars that are rated as “Good” or “Great” deals typically have 75%-80% visibility to buyers, whereas, cars that are not rated as “Good” or “Great” deals typically have 1%-3% visibility to buyers. Sometimes, the difference between a “Fair” deal and a “Good” deal can be as little as one dollar. Accordingly, adjusting the price of the vehicle by one dollar may increase buyer visibility from 1%-3% to 75%-80%.

Current systems look to historic dealer sales data to determine pricing and valuation of a vehicle. Buyers do not make buying decisions based on what is no longer for sale because they can't see a product that has sold, but rather, buyers make buying decisions based on whether a current product for sale is offered at a good deal. Current systems do not gather data based upon what marketplaces are telling buyers about a specific product. Current systems do not consolidate the data into a single location to save dealers countless hours of data acquisition and analysis. Current systems also do not utilize machine learning or provide artificial intelligence recommendations of specific actions so dealers can complete their work rapidly by showing past pivot price points, trends, possible value enhancing options, and projected pivot price points.

### SUMMARY

The present disclosure includes one or more of the features recited in the appended claims and/or the following features which, alone or in any combination, may comprise patentable subject matter.

According to a first aspect of the disclosed embodiments, a system for setting price points for a sale product includes a data collection server that is configured to collect data from display systems of a sale product, third party providers of the sale product, or combinations thereof. The data is collected to set a price point for a product. The price point is associated with the sale product by searching related pricing for the sale product. A middleware server is configured to analyze and sort the data to generate a visualization of the data. A model server is configured to tune the visualization of the data and reduce artificial intelligence hallucinations occurring in the visualization of the data. A display platform displays the visualization of the data. The display platform displays the price point for the product based on the data.

In some embodiments, of the first aspect, the data collection server may collect the data based on deal rankings assigned by the display systems which display the sale product. The middleware server may gather historical price movements of the sale product as dictated by past market conditions. The middleware server may determine current market conditions for the sale product. The middleware server may project expected future price movements for the sale product based on the current market conditions. The middleware server may project future buyer interest in the sale product based on the current market conditions. The visualization of the data may illustrate past, present, future projected price points for the product, or combinations thereof. The visualization of data may illustrate changes in a price associated with the sale product. The sale product may be an individual product. The sale product may be the product. The product may be a vehicle. The sale product may be a class of products. The product may be a member of the class of products. The product may be a vehicle.

According to a second aspect of the disclosed embodiments, a method for setting price points for a sale product includes collecting data from display systems of a sale product, third party providers of the sale product, or combinations thereof, with a data collection server. The data is collected to set a price point for a product. The price point is associated with the sale product by searching related pricing for the sale product. The method also includes analyzing and sorting the data to generate a visualization of the data with a middleware server. The method also includes tuning the visualization of the data and reducing artificial intelligence hallucinations occurring in the visualization of the data with a model server. The method also includes displaying the visualization of the data on a display platform. The display platform displays the price point for the product based on the data.

In some embodiments of the second aspect, the method may also include collecting the data based on deal rankings assigned by the display systems which display the sale product. The method may also include gathering historical price movements of the sale product as dictated by past market conditions. The method may also include determining current market conditions for the sale product. The method may also include projecting expected future price movements for the sale product based on the current market conditions. The method may also include projecting future buyer interest in the sale product based on the current market conditions. The method may also include illustrating past, present, future projected price points for the product, or combinations thereof. The method may also include illustrating changes in the price of the sale product. The sale product may be the product. The product may be a vehicle. The sale product may be an individual product. The sale product may be a class of products. The product may be a member of the class of products. The product may be a vehicle.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a schematic view of a system for setting price points for a sale product;

FIG. 2 is a flowchart of a method for setting price points for a sale product using the system shown in FIG. 1;

FIG. 3A is screenshot of part of a screen shown on a display shown in FIG. 1, wherein the screenshot includes data related to the pricing of the inventory of a car dealership;

FIG. 3B is screenshot of another part of the screen shown in FIG. 3A, wherein the screenshot includes data related to the pricing of the inventory of a car dealership;

FIG. 3C is screenshot of yet another part of the screen shown in FIG. 3A, wherein the screenshot includes data related to the pricing of the inventory of a car dealership;

FIG. 4A is a screenshot of part of another screen shown on the display shown in FIG. 1, wherein the screenshot includes data related to the pricing of the inventory of a dealership;

FIG. 4B is screenshot of another part of the screen shown in FIG. 4A, wherein the screenshot includes data related to the pricing of the inventory of a dealership;

FIG. 4C is screenshot of yet another part of the screen shown in FIG. 4A, wherein the screenshot includes data related to the pricing of the inventory of a dealership;

FIG. 5A is a screenshot of part of a yet another screen shown on the display shown in FIG. 1, wherein the screenshot includes data related to a price point of a vehicle available for sale;

FIG. 5B is screenshot of another part of the screen shown in FIG. 5A, wherein the screenshot includes data related to a price point of a vehicle available for sale;

FIG. 6A is a screenshot of part of another screen shown on the display shown in FIG. 1, wherein the screenshot data related to a sales history of the dealership;

FIG. 6B is screenshot of another part of the screen shown in FIG. 6A, wherein the screenshot includes data related to a sales history of the dealership;

FIG. 7A is a screenshot of part of yet another screen shown on the display shown in FIG. 1, wherein the screenshot includes data related a number of photos provided for each vehicle in the inventory of the dealership;

FIG. 7B is screenshot of another part of the screen shown in FIG. 7A, wherein the screenshot includes data related a number of photos provided for each vehicle in the inventory of the dealership; and

FIG. 8 is a screenshot of a screen visible to a potential buyer of a vehicle showing data related to the savings available at a vehicles listed price point; and

FIG. 9 illustrates a particular machine suitable for implementing the several embodiments of the disclosure.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the embodiments as defined by the appended claims.

The disclosed embodiments, gather daily market data on all sale products on the most important marketplaces that determine pivot price points to increase buyer visibility percentages by indicating the lowest discount necessary to sell the product, while providing profit maximization recommendations, market trending analysis, inventory turn projections and other vital sales and profit key performance indicators. Such recommendations, analysis, projections, and indicators are based on data related to a vehicle dealer's product that the marketplaces have displayed for buyers. The disclosed embodiments reflect multiple marketplaces, provide analysis, and recommendations and alerts to dealers (or other users of the disclosed systems and methods), so that dealers can save time and maximize their top and bottom line. As used herein “dealer” refers to any person or entity selling (or offering for sale) the product, for example a dealership, an individual, a manufacturer, a reseller, a service provider, a promoter, a franchisee, an owner, an operator, a manager, or the like.

The disclosed embodiments determine the optimal price for a product in order to maximize customer visibility, sales, inventory turn and profit. The disclosed embodiments collect and present historical marketplace data together with projections using statistical analysis, machine learning, and artificial intelligence to determine optimal price, possible value enhancing options, likelihood of sale, time to sell, supply, demand and other significant drivers that result in sales, inventory turn and profitability. In some embodiments, the machine learning reverse engineers the pricing algorithms of the marketplaces to assist in determining the optimal price for the product. The pivot price points are determined based on data from third-party marketplaces, which are more reflective of the actual pivot price points and price rankings presented to buyers. The data is collected and analyzed in real time, so businesses can stay up-to-date on the latest market conditions and make informed pricing decisions. The disclosed embodiments are easy to use and consolidate multiple marketplaces in one location for decision making. The disclosed embodiments take into account all of the factors that affect the price of a specific product in a specific marketplace, such as the condition, location demand and other key drivers. The refinement and training of the artificial intelligence model reveals other buyer motivations on marketplaces as the market evolves. Price ranking represents one of many evolving and fluctuating marketplace motivators of buyer behavior.

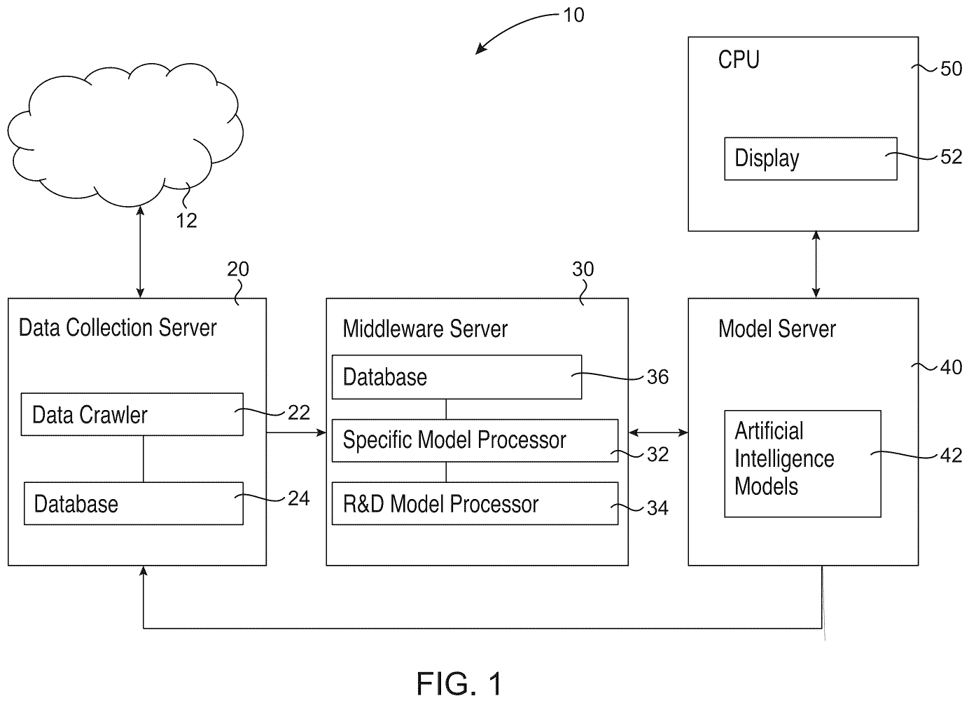

Referring to FIG. 1, a system 10 for setting price points for a product associated with a sale product is configured to crawl a network 12 including display systems of related sale products, third party providers of related sale products, or combinations thereof. Per this disclosure, a reasonable interpretation of “associated with a sale product” should be interpreted as “for a sale product” in relation to embodiments when the sale product is an individual, particularly identifiable sale product. Per this disclosure, a reasonable interpretation of “associated with a sale product” should be interpreted as “for at least one of a plurality of sale products comprising a group of sale products” in relation to embodiments when the sale product is a class of sale products. In an embodiment the sale product can be an individual product, e.g., a vehicle comprising a vehicle identification number (VIN), a ticket for a particular airline flight, a reservation at a specific hotel and/or hotel room, an event ticket, etc. In an embodiment the sale product can be a class of products, e.g., a type of vehicle (a sports utility vehicle (SUV), a truck, a sedan, a sports car, an electric vehicle, a hybrid vehicle, etc.), a brand of vehicle (Mercedes Benz®, Chevrolet®, Tesla®, Ford®, BMW®, etc.), a ticket to travel to a particular destination, a reservation for lodging in a particular location, a ticket for entertainment in a specific location, etc. In an embodiment the sale product is the product for which the price point is set. In an embodiment the sale product is one of a plurality of members of a class of products associated with the product for which the price point is set. In an embodiment the sale product is a plurality of members of a class of products associated with the product for which the price point is set. In an exemplary embodiment, the network 12 includes any internet based network or cloud based network. In one embodiment, the network 12 is the World Wide Web. Additionally, in an exemplary embodiment, the sale products include automobiles (i.e. cars, trucks, vans, motorcycles, etc.) offered for sale at an automobile dealership. In another embodiment, the sale products are any product offered for sale by a dealer, for example, vehicles such as boats, all-terrain vehicles, etc. As used herein, the sale product includes an individual vehicle, in some embodiments, or a class of vehicles, in some embodiments. The system 10 is configured for use by the dealer to determine price points for (or associated with) the sale product. In an exemplary embodiment, the display systems include, but are not limited to third party providers such as, CarGurus®, Kelly Blue Book® and Autotrader®, Cars.com®, and Carfax®. In an exemplary embodiment, the third party providers include other dealers, providers, promoters, advertisers, and displayers of the products. As used herein, these marketplaces will be referred to as Marketplace 1, Marketplace 2, Marketplace 3, and Marketplace 4.

The system 10 includes a data collection server 20 having a data crawler 22 that is configured to crawl the network 12 to collect data on products advertised on the display systems or third party providers. In some embodiments, the data crawler 22 is web-based. In some embodiments, the data crawler 22 is cloud-based. In some embodiments, the data crawler 22 is housed in a physical server of a system provider. In an exemplary embodiment, the data crawler 22 collects data related to vehicles offered for sale. In some embodiments, the system 10 utilizes machine learning to autonomously learn from previous data when to pull the data from the display systems, e.g., the system 10 utilizes machine learning to develop statistical models of the display systems' data to learn from, and also self-correct and/or adjust, for new data acquired from the display systems. In some embodiments, the system identifies critical elements that influence third party valuations and price ranking to optimize valuation and alert sellers to issues that require their attention to improve valuation. For example, the system 10, in some embodiments, uses self-learning algorithms to produce predictive models to determine when the display systems update or revise the data. Such implementation of machine learning improves the conventional functioning of the system 10 (and its components) by allowing the system 10 (and its components) to perform more efficiently, faster, and with the use of less storage capacity based on the system 10's ability to utilize machine learning to autonomously learn, develop statistical models, produce predictive models, or combinations thereof. The data from the display systems includes a make and model of the vehicle and present and past list prices for the vehicle. In some embodiments, the data also includes a mileage of the vehicle, features of the vehicle, a number of days the vehicle has been on the market, a number of photos of the vehicle, a geographic location of the vehicle, and any other provided information related to the vehicle. The data is stored in database 24.

A middleware server 30 processes and sorts the data in the database 24 and delivers sorted data to a model server 40. The middleware server 30 includes a specific model processor 32 and an R&D model processor 34 that sort data related to specific vehicle data and general vehicle data. The sorted data is stored in a database 36 and delivered to the model server 40, which includes artificial intelligence models 42 that fine tune the data to reduce artificial intelligence hallucinations occurring in a visualization of the data. In some embodiments, the system 10 utilizes machine learning to autonomously learn from previous data and determine when to update the sorting algorithms of the system 10 and/or when to alter the algorithms based on changes in the marketplace, for example the availability of new makes and models of vehicles, changes to vehicle safety and quality ratings, changes to vehicle availability, etc. For example, the system 10 utilizes machine learning to develop statistical models of the sorting algorithms to learn from, and also self-correct and/or adjust, for new data acquired from the middleware server 30 or other components of the system 10. For example, the system 10, in some embodiments, uses self-learning algorithms to produce predictive models to determine when to update or revise the sorting algorithms. Such implementation of machine learning improves the conventional functioning of the system 10 (and its components) by allowing the system 10 (and its components) to perform more efficiently, faster, and with the use of less storage capacity, while minimizing electrical current demand, based on the system 10's ability to utilize machine learning to autonomously learn, develop statistical models, produce predictive models, or combinations thereof.

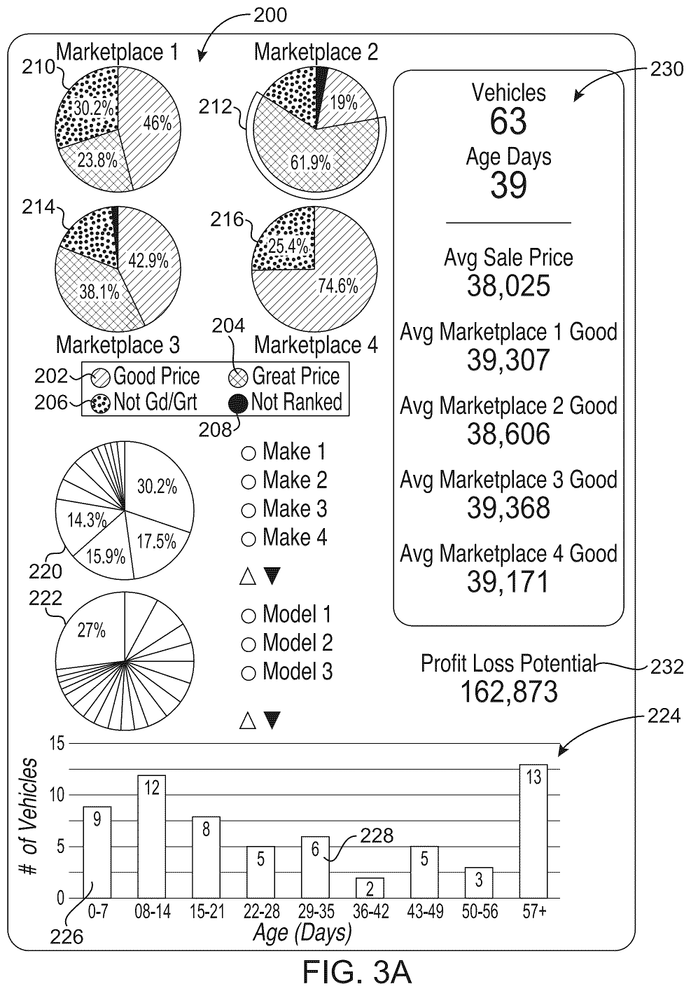

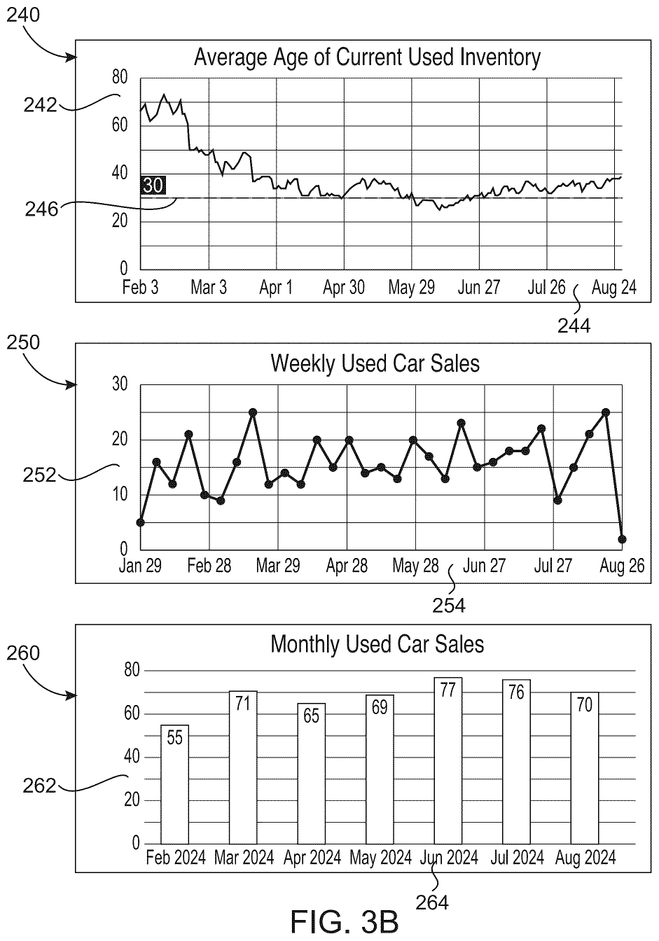

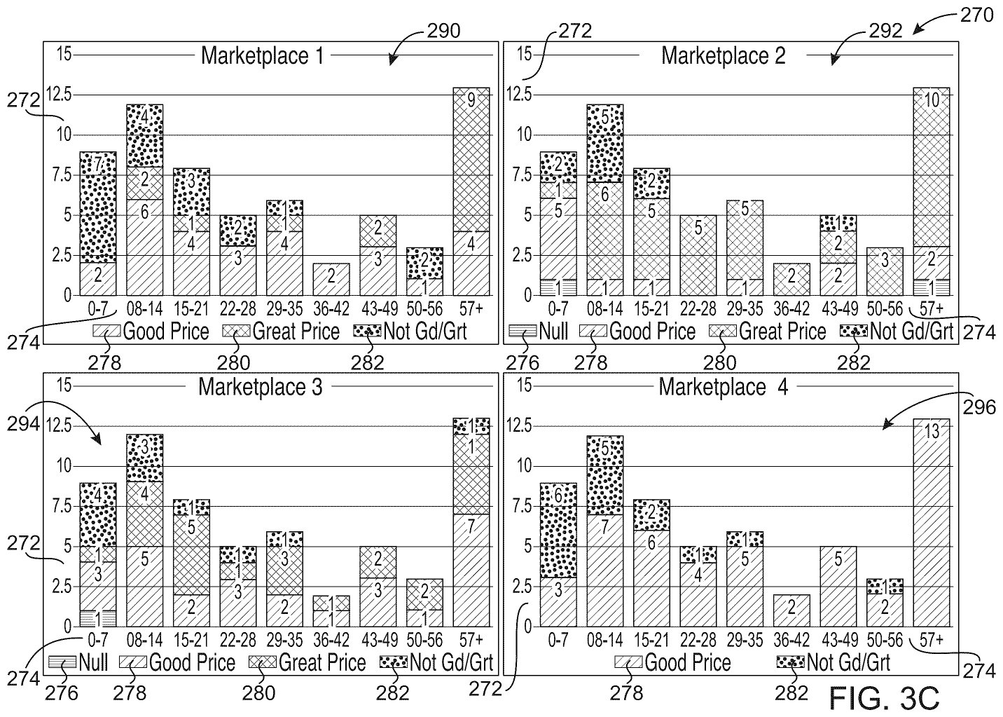

The visualization of the data is transmitted to a computer 50 having a display 52 to display the data, for example the data shown in FIGS. 3-7. The computer 50 is a desktop or handheld device, in some embodiments. The computer 50 is a device accessible by the dealership and the visualization of the data assists the dealership in setting price points for, or associated with, vehicles on the dealership's lot.

The data collection server 20; the middleware server 30 connecting data sources for the artificial intelligence models 42, including a find-tuned specialized artificial intelligence model and a fundamental artificial intelligence model; cloud; infrastructure layers; and application layers run on servers to create an online user interface dashboard accessible via a Web URL that is password protected. The end user goes to that URL on the display 52, logs on, and is presented with the visualization of the data, price projections, possible value enhancing options, price history and artificial intelligence recommendations collectively. The visualization of data is displayed as graphs and tables that the user can use to establish and change price points of a sale product. The visualization of data allows the user to see an artificial intelligence projected impact on retail buyer visibility. The dashboard also determines increased profit potential without impacting price ranking by providing specific price points to maximize sales, turn, and profitability. In some embodiments, the system 10 utilizes machine learning to autonomously learn from previous data and determine when price points should be updated and/or when the data displayed as part of the visualization of the data should be updated.

At any given time of execution (user entering the URL), the refinement steps of the system 10 would not be needed, however, continuous improvement, training of the fundamental and refined artificial intelligence models will allow the system 10 to continue to provide improved visualizations, analysis and recommendations. The continued trailing of the artificial intelligence models will improve the artificial intelligence's relevance, reduce hallucinations and improve response to market fluctuations, thus providing better recommendations to the user. The system 10 enables the user to determine, gather and analyze what marketplaces are saying about a specific product and determine its impact on retail buyer visibility and buying behavior.

The major categories of data collection, middleware, fine-tuned specialized artificial intelligence model, cloud and infrastructure layer, foundational model, application layer and model training and refinement could be run in any order or separated into independent or grouped actions without impacting the usability of the system 10.

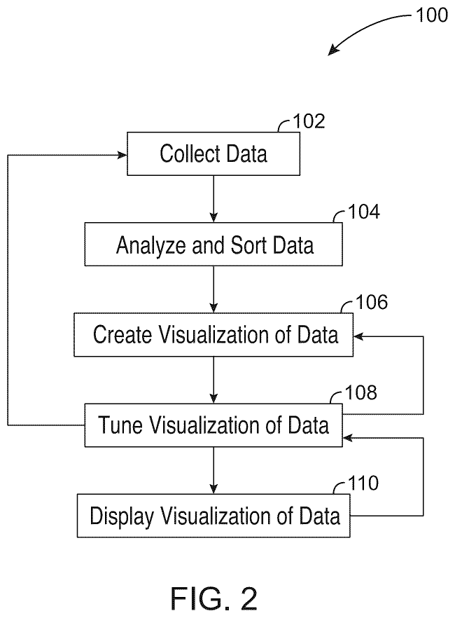

Referring now to FIG. 2, a method 100 for setting price points associated with a sale product includes collecting data, at block 102, from display systems of related products and third party providers of related products, wherein the related products are similar to the sale product and wherein the data is related to a price of the related products. The system 10 collects data from third-party marketplaces about the product along with a price point based on a deal ranking on each marketplace for each product. Starting with the data collection stage, a series of filters cull and organize the data to reduce artificial intelligence hallucinations and improve the quality of analysis. In some embodiments, the system 10 utilizes multi-level synchronized filtering.

At block 104, the data is analyzed and sorted. The data is analyzed to gather historical price movements for products and determine current market conditions. The data is further analyzed to determine sales events including sales, market days and other key market results. Artificial intelligence and statistical analysis methods are applied to project expected future price movements for a specific product and to gather and project buyer interest. The data is then fed to the fine-tuned specialized artificial intelligence models using flow and infrastructure layers running artificial intelligence algorithms that inform foundational models and provide application layers that create user visualizations of the data, at block 106. Humans use the visualizations to establish price points that will increase retail visibility on marketplaces while staying within price rankings to maximize unit sales and profit.

As discussed in more detail below, the dashboard visualizations are configurable to include graphs and specific values that show the sale product's past, present, future projected pivot price points, or combinations thereof. The visualizations and data are used to track the price movements of the automotive vehicle and to identify the optimal price for the product, in some embodiments. The visualizations use various coloring (illustrated in a different shading in FIGS. 3-7) to draw attention to issues that need to be addressed. The visualizations show the overall market trends and specific price point and image recommendations to improve or protect buyer visibility. The visualizations also show aging inventory and pivot price point analysis and recommendations. An overall inventory status and individual project detail dashboard is provided for drill down decision making. In some embodiments, the visualization of data includes photo analysis and impact on buyer visibility, marketplace price ranking and pivot pricing status, inventory recommendation analysis, and inventory loan risk analysis.

At block 108, the visualization of data is tuned to reduce artificial intelligence hallucinations occurring in the visualization of the data. Tuning occurs by refine the structured filtration of the data set and connecting the data to the artificial intelligence models. The fine-tuned specialized artificial intelligence models are trained on the systems refined data set. A cloud and infrastructure layer provides the computing power and storage needed to run artificial intelligence algorithms ensuring security and scalability needed to protect data and ensure that artificial intelligence models can be accessed by authorized users/algorithms. The system 10 provides refined foundational models for a wider range of research and focused development. The data, fine-tuned and foundational artificial intelligence models and cloud and infrastructure layers are then reviewed and refined to provide improved application specific data and model training. This includes the categorization, quality and statistically significance. Alarms and alerts are set at the client level that are model-based engineering logic notification gates. The artificial intelligence models are trained and develop logic gates within the refined and foundational models in a recurring loop of refinement responding to market data and expert training of the artificial intelligence model.

At block 110, the visualization of data is displayed on the display 52. The end user goes to the system URL, logs on and is presented with the visualization of the data that the user can use to establish and change price points of a sale product and see its artificial intelligence projected impact on retail buyer visibility. The dashboard also determines increased profit potential without impacting price ranking to provide specific price points to maximize sales, turn and profitability. The end user would enter the URL, select one of their products, view the recommendations, price history, price ranking and make a decision on product pricing that they would then adjust on their inventory system that feeds pricing information to these marketplaces. The embodiments can be used on any marketplace where the marketplace is providing buyers using the marketplace with an opinion about the product. This could include automotive, travel, clothing or any other retail, wholesale or business to business products where opinions presented on a marketplace influence buyer purchasing behavior. The refinement and training of the artificial intelligence model will reveal other buyer motivations on marketplaces as the market evolves. Price ranking represents one of many evolving and fluctuating marketplace motivators of buyer behavior.

FIGS. 3A-3C are screenshots of the visualization of data showing an overview of vehicle in inventory at a dealership. The data displayed in FIGS. 3A-3C is used by the dealership to assess the current prices on dealership inventory. In some embodiments, the dealership utilizes this data to set price points for the inventory in the good deal to great deal range, thereby increasing the visibility of each vehicle on third party marketplaces. A total profit loss potential 232 represents a total amount of price increases that can be made on products without losing a deal ranking on any marketplace.

The pie charts 200 illustrate a percentage of cars in inventory that are displayed as good deals (shown with shading 202), great deals (shown with shading 204), not good/great (shown with shading 206) deals, or not ranked (shown with shading 208) in each marketplace. For example, on Marketplace 1 (shown in chart 210), 30.2% of the vehicles in the dealership's inventory are displayed as not good/great deals, 46% of the vehicles in the dealership's inventory are displayed as good deals, and 23.8% of the vehicles in the dealership's inventory are displayed as great deals. In another example, on Marketplace 2 (shown in chart 212), 19% of the vehicles in the dealership's inventory are displayed as good deals, 61.9% of the vehicles in the dealership's inventory are displayed as great deals, and the remaining vehicles in the dealership's inventory are not displayed or are displayed as not good/great deals. In yet another example, on Marketplace 3 (shown in chart 214), 42.9% of the vehicles in the dealership's inventory are displayed as good deals, 38.1% of the vehicles in the dealership's inventory are displayed as great deals, and the remaining vehicles in the dealership's inventory are not displayed or are displayed as not good/great deals. In a further example, on Marketplace 4 (shown in chart 216), 74.6% of the vehicles in the dealership's inventory are displayed as good deals, and 25.4% of the vehicles in the dealership's inventory are displayed as not good/great deals. It should be noted that in the exemplary embodiments, Marketplace 4 does not rank vehicles as great.

A pie chart 220 illustrates the percentage of each vehicle make in the dealership's inventory. Another pie chart 222 illustrates the percentage of each model of vehicle in the dealership's inventory. A bar chart 224 illustrates a number of vehicles in the dealership's inventory based on a number of days that the vehicles have been in the dealership's inventory. For example, 9 vehicles 226 have been in the dealership's inventory for 0-7 days. In another example, 6 vehicles 228 have been in the dealership's inventory for 29-35 days. A graph 230 displays inventory data. For example, in the illustrated embodiment, the dealership's inventory includes 63 vehicles that are aged an average of 39 days in inventory. The average sale price for each vehicle is $38,025, the average Marketplace 2 good value for the dealer's entire inventory is $39,307, the average Marketplace 1 good value for the dealer's entire inventory is $38,606, the average Marketplace 3 good value for the dealer's entire inventory is $39,368, and the average Marketplace 4 good value for the dealer's entire inventory is $39,171.

A line graph 240 illustrates an average age of vehicles in the dealership's inventory (on the y-axis 242) over time (on the x-axis 244). In an exemplary embodiment, the average of the vehicles is shown in days and the time is shown as calendar days. In the illustrated embodiment, a line 246 indicates 30 days in inventory so that the user can easily determine whether the average days in inventory is less than or greater than 30 days on any given location in the graph. It will be appreciated that the line 246 can be adjusted to reflect any average number of days including less than 30 days or more than 30 days.

A line graph 250 illustrates a number of vehicle sales at the dealership (on the y-axis 252) over time (on the x-axis 254). In the exemplary embodiment, the time is shown as calendar weeks. That is, each point on the graph represents a number of vehicles sold in each calendar week. A bar graph 260 illustrates a number of vehicle sales at the dealership (on the y-axis 262) over time (on the x-axis 264), wherein the time is shown as calendar months. That is, each bar on the graph represents a number of vehicles sold in each calendar month.

Bar graphs 270 illustrate vehicle retail buyer visibility per days in the inventory bucket as reflected by individual marketplaces. The age groups of the vehicles are illustrated as bars along the x-axis 274 and the number of vehicles in each age group is represented by a height of each bar on the y-axis 272. The bars are shaded or colored based on the value of each vehicle represented in the bar. For example, vehicles that are not listed on the marketplace are represented by a shading or coloring 276. Vehicles that are listed on the marketplace as good deals are represented by a shading or coloring 278. Vehicles that are listed on the marketplace as great deals are represented by a shading or coloring 280. Vehicles that are listed on the marketplace as not good/great deals are represented by a shading or coloring 282. The graph 290 represents the deals for each car in the dealership's inventory on the Car Gurus® marketplace. The graph 292 represents the deals for each car in the dealership's inventory on Marketplace 2. The graph 294 represents the deals for each car in the dealership's inventory on Marketplace 3. The graph 296 represents the deals for each car in the dealership's inventory for each car in the dealership's inventory on Marketplace 4.

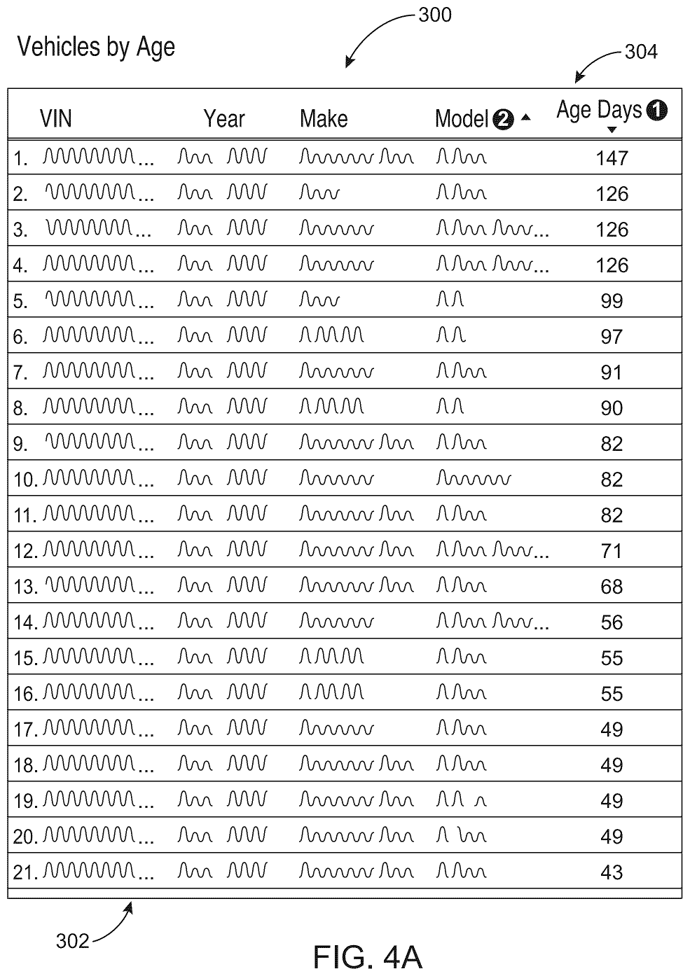

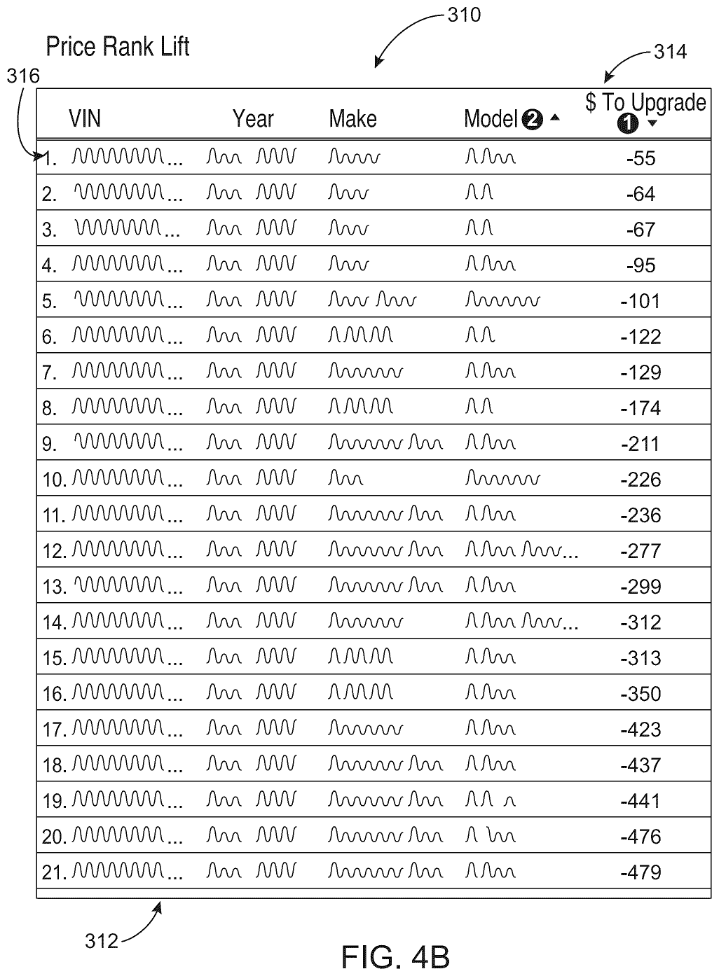

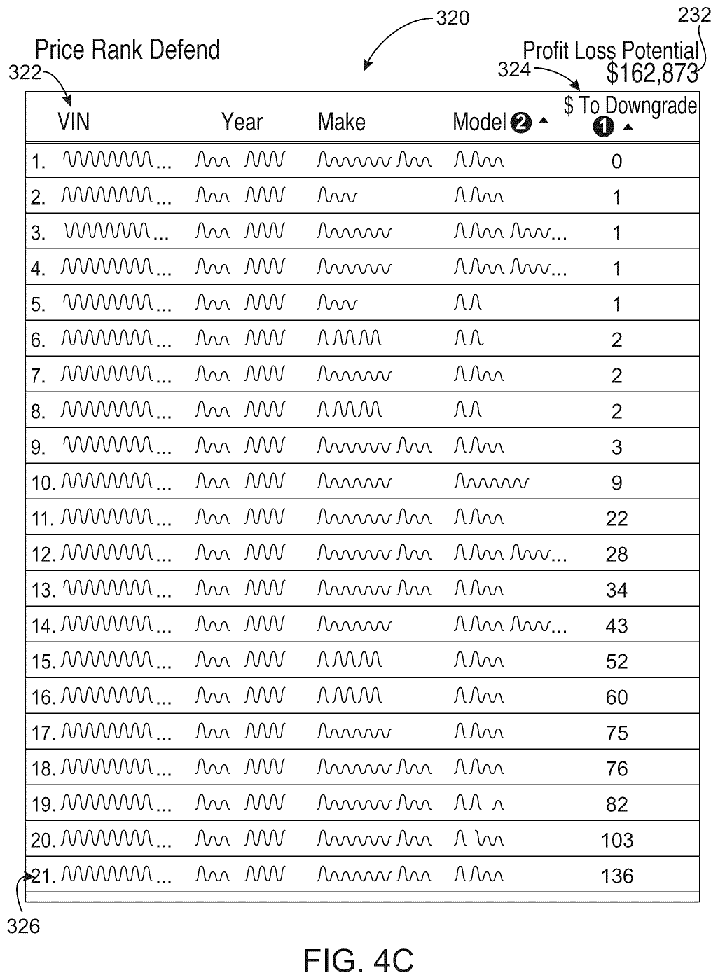

FIGS. 4A-4C illustrate screenshots of the visualization of data related to the pricing of the dealership's inventory. A chart 300 illustrates a list 302 of each vehicle in the dealership's inventory by VIN number. In the illustrated embodiment, the list 302 also includes a year, make, and model of each vehicle in the list 302. An age of the vehicle in column 304 represents the number of days each vehicle has been in the dealership's inventory.

A chart 310 illustrates a list 312 of each vehicle in the dealership's inventory by VIN number. In the illustrated embodiment, the list 312 also includes a year, make, and model of each vehicle in the list 312. The column 314 represents the necessary decrease in dollars of each vehicles price to achieve a better ranking on at least one marketplace. For example, the vehicle 316 in the list 312 requires a $55 decrease in price to be moved to a better deal on at least one marketplace. In one example, the decrease in price moves the vehicle from a not good/great deal ranking to a good deal ranking in at least one marketplace, in some embodiments. In another example, the decrease in price moves the vehicle from a good deal ranking to a great deal ranking in at least one marketplace, in some embodiments.

A chart 320 illustrates a list 322 of each vehicle in the dealership's inventory by VIN number. In the illustrated embodiment, the list 322 also includes a year, make, and model of each vehicle in the list 322. The column 324 represents an increase in dollars for each vehicle that provides the highest vehicle price without lowering the vehicle's ranking on at least one marketplace and signals a projected valuation that would cause the vehicle to lose a price ranking, thus losing retail buyer visibility. For example, the vehicle 326 in the list 322 can be increased in price by $136 and maintain its deal ranking on at least one marketplace. In one example, the increase in price maintains a good deal ranking in at least one marketplace, in some embodiments. In another example, the increase in price maintains a great deal ranking in at least one marketplace, in some embodiments. The total profit loss potential 232 represents a total amount of profits that the dealership could lose if the dealership does not adjust their prices to more rapidly move inventory.

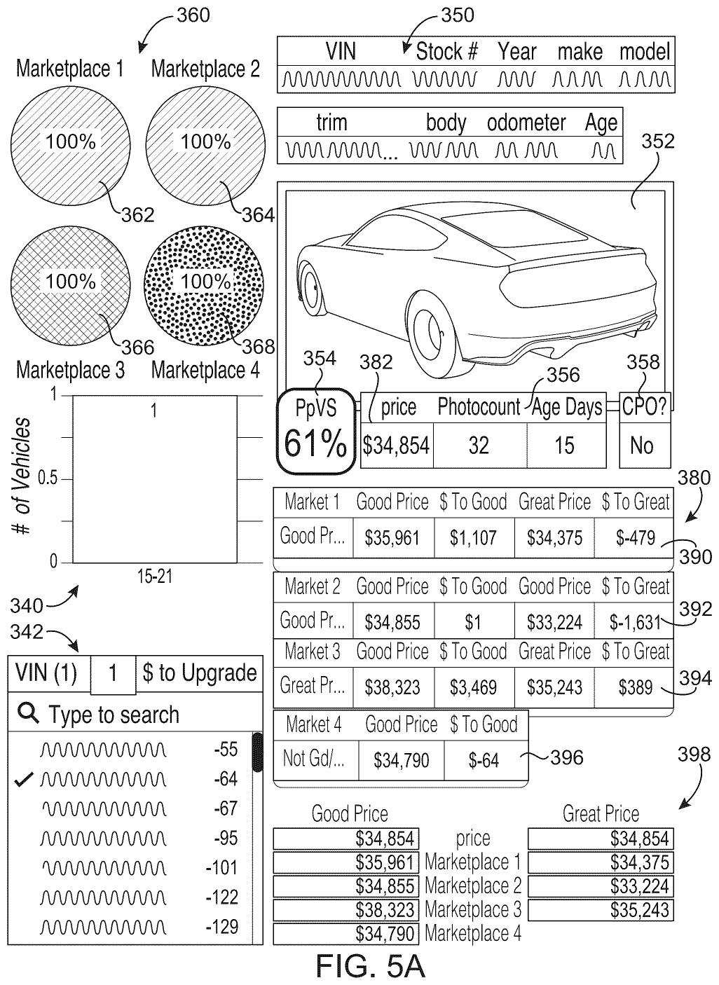

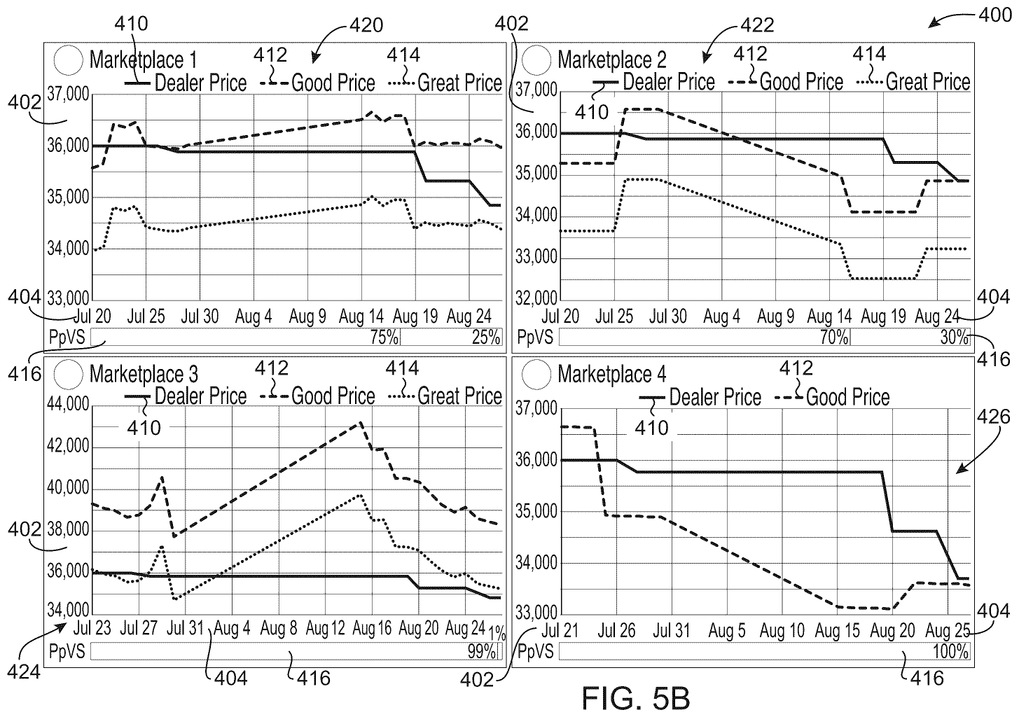

FIGS. 5A-5B are screenshots of the visualization of data related to a price point of a vehicle available for sale in the dealership's inventory. The data for an individual vehicle is selectable by selecting a vehicle from any of the charts 300, 310, or 320. A chart 340 displays the number of vehicles in each age group. In the exemplary embodiment, since only one vehicle is selected, the chart 340 only lists the one vehicle. The data for each individual vehicle may also be selected from a chart 342 that lists each vehicle by price decrease required to upgrade the vehicle ranking. It will be appreciated, that the chart can be toggled to list inventory of vehicles by potential price increase while maintaining deal ranking or by days in inventory. In an exemplary embodiment, a chart 350 includes vehicle data. In an exemplary embodiment, the vehicle data includes the VIN number, stock number, year, make, model, trim, body, odometer reading, and age (days in inventory) of the individual vehicle. A display 352 illustrates a photo of the individual vehicle. In some embodiments, the display 352 is configured to be toggled to show other photos of the individual vehicle. A visibility percentage 354 indicates a percentage of buyers that have visibility of the individual vehicle across all marketplaces.

In some embodiments, artificial intelligence is a multivariate component updated in real time based on machine learning. Artificial intelligence is used to measure and make specific recommendations that impact the buyer visibility of the products on each marketplace. In some embodiments, the buyer visibility driven by artificial intelligence finds elements (marketplace, service history, make/model/trim traffic, etc.) that impact overall buyer visibility in marketplace then provide dealers with specific details to more efficiently drive make, model, trim, product acquisition, product mix, product presentation (descriptive text, photos, etc.), place (reputation, facilities, descriptive text, photos, etc.), price, timing, promotion (where to advertise, how much to spend, packages, etc.), and people to target. In some embodiments, the buyer visibility driven by artificial intelligence is affected by implementing possible value enhancing options recommended, suggested, or otherwise identified by the artificial intelligence employed and utilized by the disclosed systems and methods. In some embodiments, the artificial intelligence identified possible value enhancing options comprise increasing the number of images of the product displayed, performing certain maintenance actions on the product (e.g., installing new tires, adding new flooring, and increasing leg room for passengers), offering an extended warranty, offering complimentary maintenance service for a defined period of time post purchase, and other value increasing offerings and/or services that would be known to those of ordinary skill in the art. In some embodiments, the disclosed systems and methods utilize artificial intelligence, machine learning, or combinations thereof, to reverse engineer the value establishing algorithms of the various marketplaces and are configured to utilize the reverse engineered algorithms to develop, generate, create, and/or provide the possible value enhancing options for utilization by the disclosed system and methods (and users of said disclosed system and methods). In embodiments, a possible value enhancing option, based on the reverse engineered value establishing algorithm of a marketplace or the reverse engineered value establishing algorithms of a plurality of marketplaces, materially affect a product's ranking without a concomitant change in a price of the product. The goal of the system 10 is to increase the visibility percentage 354 as much as possible. In embodiments, the increase in visibility can result in an increase of an original visibility percentage of 0% to an increased visibility percentage of 100%. Further, any increase in visibility percentage can be any incremental percentage value between an original visibility percentage and a subsequent visibility percentage. In embodiments, the increase in visibility percentage can be about 1%-100%. In embodiments, the increase in visibility percentage can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 100%. A data box 356 illustrates a current list price of the individual vehicle at the dealership, a number of photos of the vehicle available online, and the age (days in inventory) of the individual vehicle. A box 358 indicates whether the individual vehicle is certified pre-owned.

Pie charts 360 illustrate a visibility percentage of the vehicle on each marketplace as a great deal, good deal, not good/great deal, or not ranked. In the illustrated embodiment, chart 362 indicates that the selected vehicle has 100% visibility as a good deal on Marketplace 1, chart 364 indicates that the selected vehicle has 100% visibility as a good deal on Marketplace 2, chart 366 indicates that the selected vehicle has 100% visibility as a great deal on Marketplace 3, and chart 368 indicates that the selected vehicle has 100% visibility as a not good/great deal on Marketplace 4. It will be appreciated that each of the charts 360 can be divided into separate percentages that represent less than 100% of valuations on each marketplace. For example, the vehicle may be a ranked as a not good/great deal for 30% of the valuations on the marketplace, ranked as a good deal for 30% of the valuations on the marketplace, and ranked as a great deal for 40% of the valuations on the marketplace.

The charts 380 illustrate the current Good and Great price valuation that a specific marketplace placed on the selected vehicle together with the difference between the dealer's price, 382, which, in the exemplary embodiment, is $34,854, and the Good or Great price. Chart 390 illustrates the difference between the dealer's price and the Good or Great price for the vehicle on Marketplace 1. The good price ranking on Marketplace 1 is $35,961. Accordingly, the dealership could increase the dealer's price by $1,107 and maintain a good ranking. However, the great price on Marketplace 1 is $34,375. Accordingly, the dealer must drop the dealer's price $479 to achieve a great ranking. Chart 392 illustrates the difference between the dealer's price and the Good or Great price on Marketplace 2. The good price ranking on Marketplace 2 is $34,855. Accordingly, the dealership could increase the dealer's price by $1 and maintain a good ranking. However, the great price on Marketplace 2 is $33,224. Accordingly, the dealer must drop the dealer's price $1,631 to achieve a great ranking. Chart 394 illustrates the difference between the dealer's price and the Good or Great price on Marketplace 3. The good price ranking on Marketplace 3 is $38,323. Accordingly, the dealership could increase the dealer's price by $3,469 and maintain a good ranking. However, the great price on Marketplace 3 is $35,243. Accordingly, the dealer could increase the dealer's price by $389 and maintain a great ranking. Chart 396 illustrates the difference between the dealer's price and the Good price on Marketplace 4. The good price ranking on Marketplace 4 is $34,790. Accordingly, the dealership must drop the dealer's price $64 to achieve a good ranking. The bar charts 398 display the good and great prices for each marketplace.

Graphs 400 illustrate a history of the dealer's price as compared to a history of good prices and great prices over time, wherein price is illustrated on the y-axis 402 and time is illustrated on the x-axis 404. The dealer's price is reflected in line 410, the good price is reflected in line 412, and the great price is reflected in line 414. A bar 416 illustrates a percentage of buyers that have visibility of the individual vehicle on each marketplace. Graph 420 illustrates the valuation history on Marketplace 1, wherein the valuation history includes the dealer's price, fair, good, and great valuations, graph 422 illustrates the valuation history on Marketplace 2, the graph 424 illustrates the valuation history on Marketplace 3, and graph 426 illustrates the valuation history on Marketplace 4. The data in the graphs 400 is utilized to populate the pie charts 360.

The dealership utilizes the data shown in FIGS. 5A-5C to adjust the price of each vehicle by bringing the price into good or great rankings as compared to similar vehicles on the various marketplaces. Improving the deal ranking of the vehicle on as many marketplaces as possible facilitates increasing the visibility percentage 354. Many marketplaces need to improve visibility percentage 354 to turn the vehicle, increase sales, and increase profit.

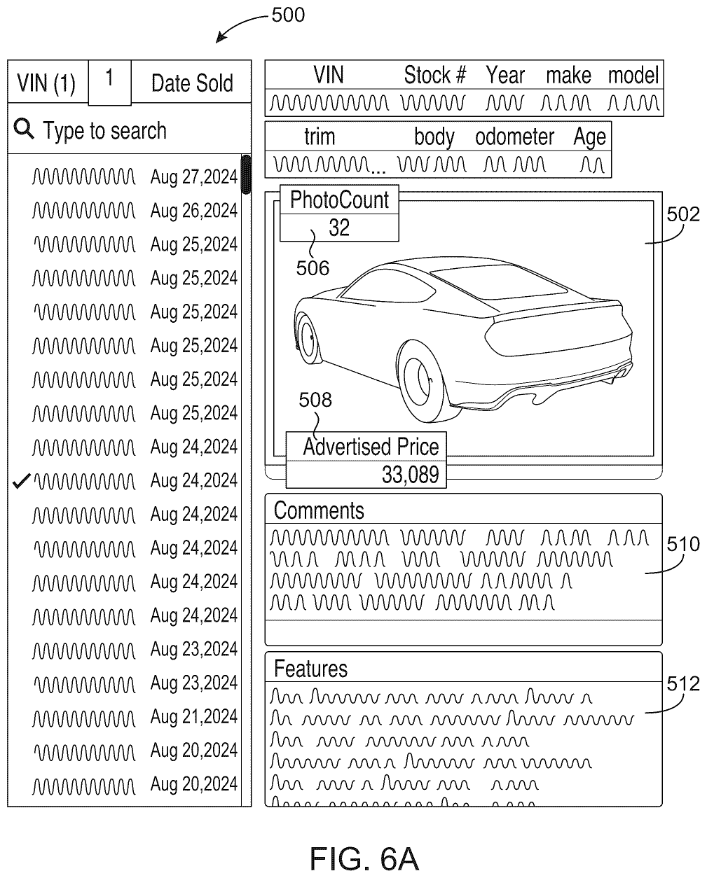

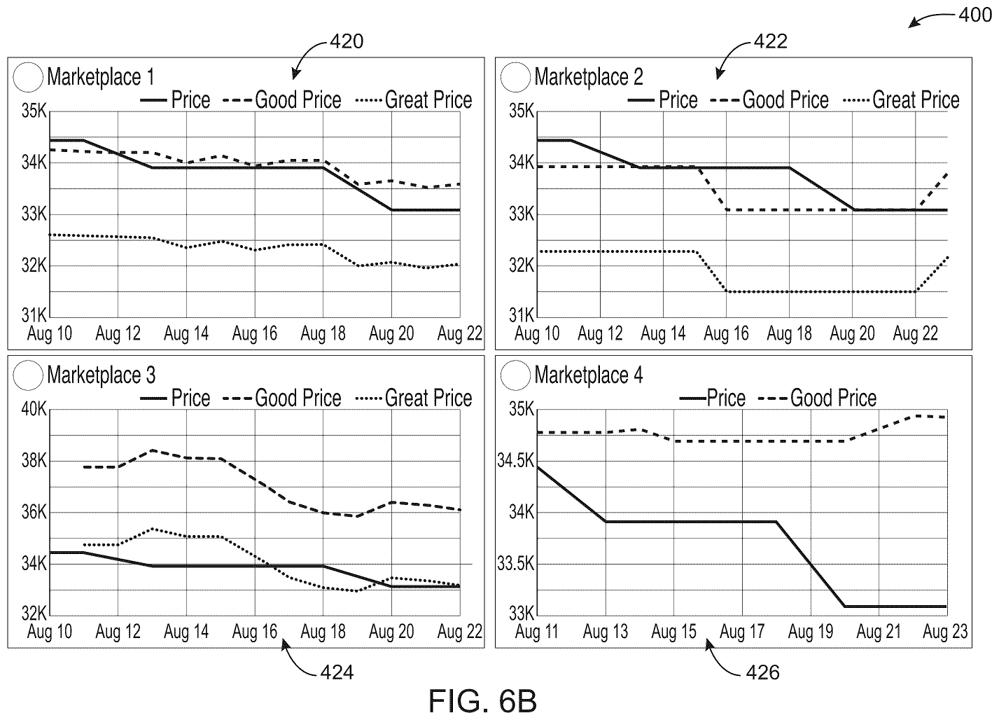

FIGS. 6A-6B are screenshots of the visualization of data related to a sales history of the dealership. A list 500 includes each vehicle that the dealership has sold in a predetermined period of time. The vehicles are listed by VIN number and date sold. Selecting a vehicle from the list 500 populates a photo 502 of the vehicle and vehicle data 504. The vehicle is displayed along with a photo count 506 and the vehicle advertised price 508. Comments 510 regarding the sale and features 512 of the vehicle are provided under the photo. The historical graphs 400 for each vehicle are also provided for future research and pricing of similar vehicles.

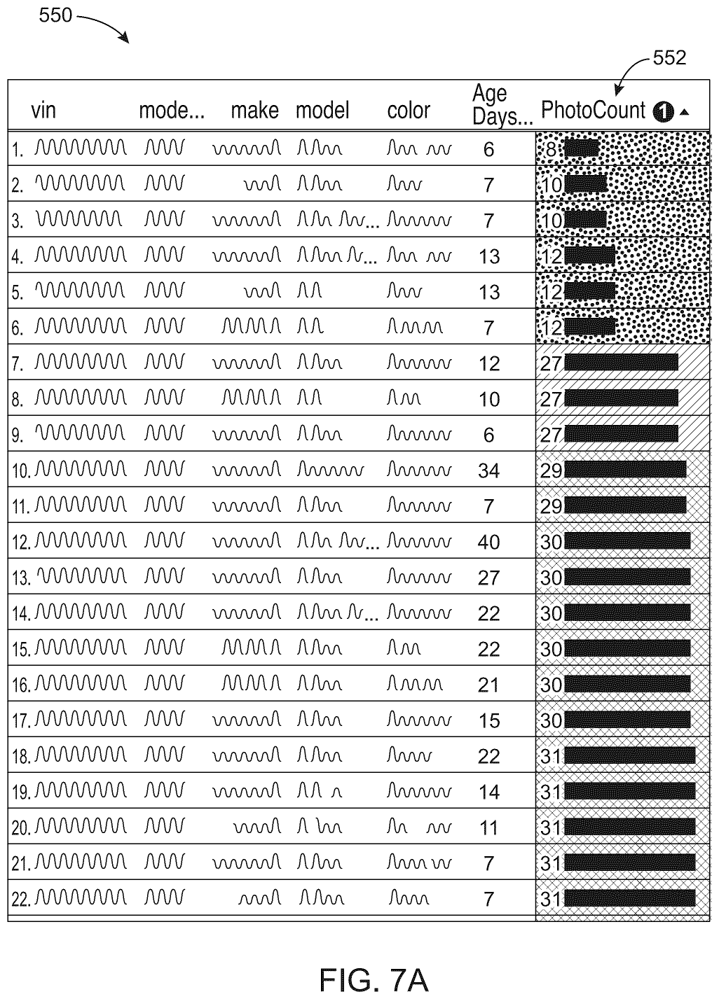

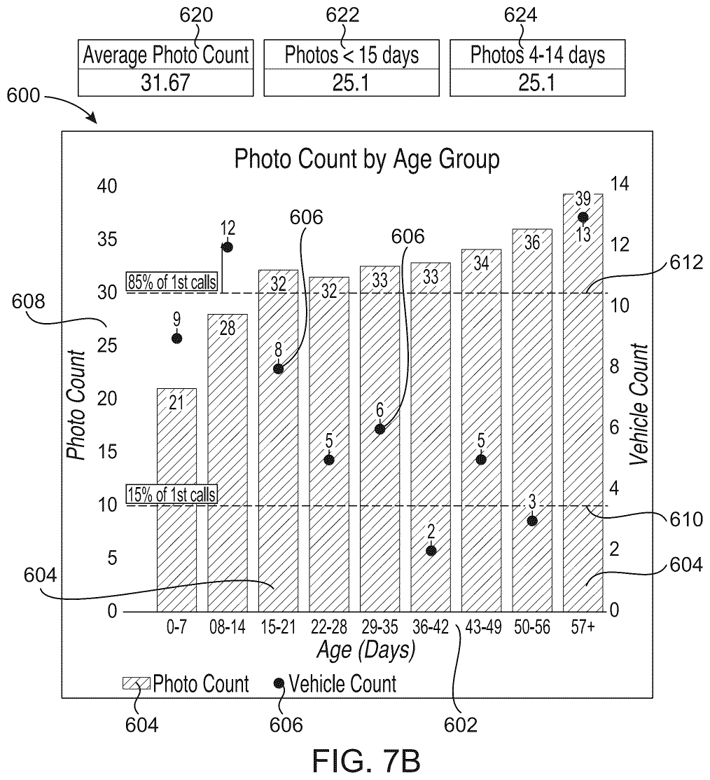

FIGS. 7A-7B are screenshots of the visualization of data related to a number of photos provided for each vehicle in the dealership's inventory. A list 550 of each vehicle includes a column 552 that indicates the number of photos available online for each vehicle. The column 552 is shaded or colored, in some embodiments, to identify vehicles with a good photo count and vehicles with a bad photo count. In some embodiments, vehicles with a good photo count are shaded or colored in a first shade or color (for example, green), and vehicles with a bad photo count are shaded or colored in a second shade or color (for example, red).

The graph 600 illustrates an inventory age of each vehicle on the x-axis 602 and both photo count (illustrated as bars 604) and number of vehicles (illustrated as points 606) on the y-axis 608. A line 610 represents the number of photos necessary for a vehicle to be visible to 15% of buyers in a first visit to a marketplace, and a line 612 represents the number of photos necessary for a vehicle to be visible to 85% of buyers in a first visit to a marketplace. In some embodiments, artificial intelligence will update these percentages in real time. The average photo count for each vehicle in the dealership's inventory is shown in box 620. The average photo count for each vehicle in the dealership's inventory for less than 15 days is shown in box 622. The average photo count for each vehicle in the dealership's inventory for 4-14 day is shown in box 624.

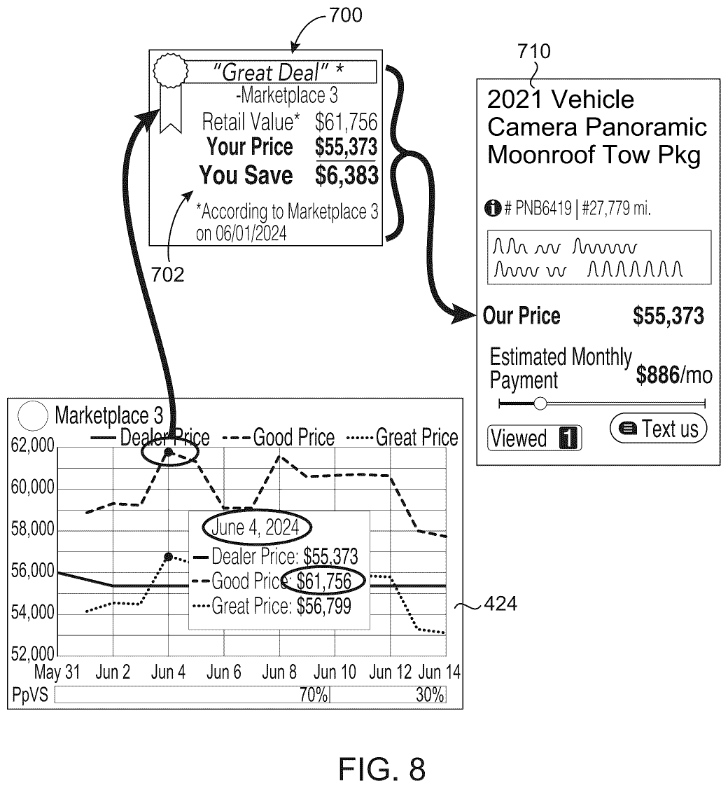

FIG. 8 is a screenshot of screens 700 and 710 visible to a potential buyer of a vehicle on a third party device, such as a computer or handheld device. The screen 700 illustrates an amount of savings available at the currently listed price provided by the dealership. The screen 700 reflects the best value over each marketplace. For example, if the dealer's price is $6,383 less than the best great deal on Marketplace 3, and the dealer's price is also $5,000 less than the best great deal on Marketplace 1, the screen 700 will show a total savings 702 of $6,383 as reflected by the Marketplace 3 great deal rankings.

All of, or a portion of, the system 10 described above may be implemented on any particular machine (or machines), e.g., any particular electronic component (or electronic components), with sufficient processing power, memory resources, and throughput capability to handle the necessary workload placed upon the computer, or computers. System 10 (and its constituent components) are configured to utilize machine learning to: (i) autonomously learn from previous data and/or activities; (ii) develop statistical models of data to learn from, self-correct, adjust, or combinations thereof, for new data acquired by the systems 10 and/or its components; (iii) recognize patterns from data; and (iv) use self-learning algorithms to produce predictive models to determine when to update, modify, alter, or reconfigure the processes of system 10, the components of system 10, the processes of the components of system 10, the data sought, acquired, analyzed, produced, and/or displayed by system 10, or combinations thereof. Such implementation of machine learning improves the conventional functioning of the system 10 (and its components) by allowing the system 10 (and its components) to perform more efficiently, faster, and with the use of less storage capacity based on the system 10's ability to utilize machine learning to autonomously learn, develop statistical models, recognize patterns, produce predictive models, or combinations thereof. System 10 (and its constituent components) are also configured to utilize artificial intelligence to perform the complex tasks required for setting price points disclosed herein by: (i) utilizing structured data, semi-structured data, unstructured data, or combinations thereof to make decisions; (ii) utilizing logic and decision trees to learn, reason, self-correct, or combinations thereof; and (iii) analyzing and contextualizing data to provide information, and/or automatically trigger actions, without human action and/or interference. Such implementation of artificial intelligence improves the conventional functioning of the system 10 (and its components) by allowing the system 10 (and its components) to: (i) utilize structured data, semi-structured data, unstructured data, or combinations thereof to make decisions; (ii) utilize logic and decision trees to learn, reason, self-correct, or combinations thereof; and (iii) analyze and contextualize data to provide information, and/or automatically trigger actions, without human action and/or interference-such capabilities being impossible for a legacy computer system or its components without employing artificial intelligence.

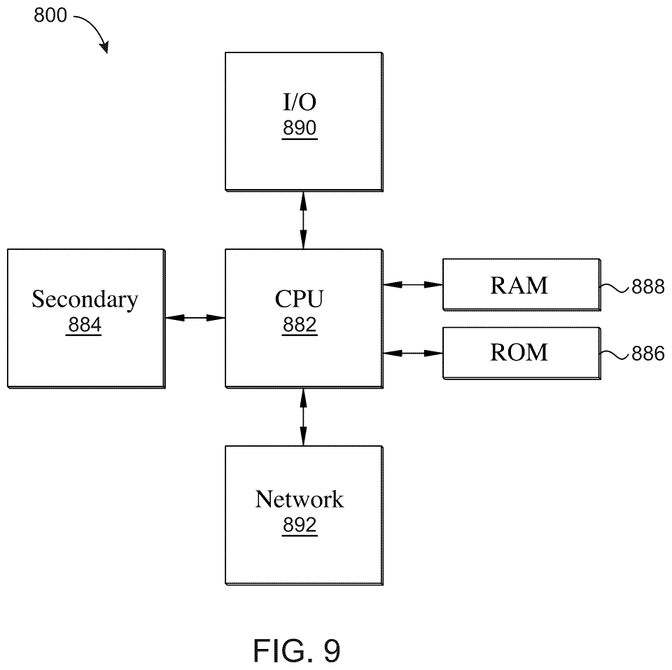

FIG. 9 illustrates a computer system 800 suitable for implementing all, or a portion of, one or more embodiments disclosed herein. The computer system 800 includes a processor 882 (which may be referred to as a central processor unit or CPU which, in some embodiments comprise at least one microprocessor and in some embodiments comprise a plurality of microprocessors) that is in communication with memory devices including secondary storage 884, read only memory (ROM) 886, random access memory (RAM) 888, input/output (I/O) devices 890, and network connectivity devices 892. The processor 882 may be implemented as one or more CPU chips.

It is understood that by programming and/or loading executable instructions comprising the above detailed method for setting price points onto the computer system 800 (e.g., onto the microprocessor(s)), at least one of the CPU 882, the RAM 888, and the ROM 886 are changed, transforming the computer system 800 in part into a particular machine or apparatus having the novel functionality taught by the present disclosure and improving the functionality of the computer system by utilizing the programmed machine learning to identify, filter, and process acquired data to determine real-time price point values and value ranges and to predict future price point values and ranges, none of which could be done without the implementation of the instantly described methods for setting price points in executable instructions performed by the components of the disclosed computer system. The implementation of the instantly described methods for setting price points in executable instructions by the disclosed computer system also improves the functionality of the computer system and its components via the programmed machine learning and artificial intelligence implementation by causing the computer system and its components to utilize less storage, process data in real time and dynamically at faster processing speeds, utilize multilevel filtering to effectuate the improvements to the computer system and its components, and to cause the computer system and its components to process and analyze data in a manner which is humanly impossible. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 884 is typically comprised of one or more disk drives or tape drives and is used for non-volatile storage of data and as an overflow data storage device if RAM 888 is not large enough to hold all working data. Secondary storage 884 may be used to store programs which are loaded into RAM 888 when such programs are selected for execution. The ROM 886 is used to store instructions and perhaps data which are read during program execution. ROM 886 is a non-volatile memory device which typically has a small memory capacity relative to the larger memory capacity of secondary storage 884. The RAM 888 is used to store volatile data and perhaps to store instructions. Access to both ROM 886 and RAM 888 is typically faster than to secondary storage 884. The secondary storage 884, the RAM 888, and/or the ROM 886 may be referred to in some contexts as computer readable storage media and/or non-transitory computer readable media.

I/O devices 890 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 892 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 892 may enable the processor 882 to communicate with the Internet or one or more intranets. With such a network connection, it is contemplated that the processor 882 might receive information from the network, or might output information to the network in the course of performing the above-described method steps. Such information, which is often represented as a sequence of instructions to be executed using processor 882, may be received from and outputted to the network, for example, in the form of a computer data signal embodied in a carrier wave.

Such information, which may include data or instructions to be executed using processor 882 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 882 executes instructions, codes, computer programs, scripts which it accesses from hard disk, floppy disk, optical disk (these various disk based systems may all be considered secondary storage 884), ROM 886, RAM 888, or the network connectivity devices 892. While only one processor 882 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 884, for example, hard drives, floppy disks, optical disks, and/or other device, the ROM 886, and/or the RAM 888 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 580 to provide the functionality of a number of servers that is not directly bound to the number of computers in the computer system 580. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 884, to the ROM 886, to the RAM 888, and/or to other non-volatile memory and volatile memory of the computer system 800. The processor 882 may process the executable instructions and/or data structures in part by directly accessing the computer program product, for example by reading from a CD-ROM disk inserted into a disk drive peripheral of the computer system 800. Alternatively, the processor 882 may process the executable instructions and/or data structures by remotely accessing the computer program product, for example by downloading the executable instructions and/or data structures from a remote server through the network connectivity devices 892. The computer program product may comprise instructions that promote the loading and/or copying of data, data structures, files, and/or executable instructions to the secondary storage 884, to the ROM 886, to the RAM 888, and/or to other non-volatile memory and volatile memory of the computer system 800.

In some contexts, the secondary storage 884, the ROM 886, and the RAM 888 may be referred to as a non-transitory computer readable medium or a computer readable storage media. A dynamic RAM embodiment of the RAM 888, likewise, may be referred to as a non-transitory computer readable medium in that while the dynamic RAM receives electrical power and is operated in accordance with its design, for example during a period of time during which the computer 800 is turned on and operational, the dynamic RAM stores information that is written to it. Similarly, the processor 882 may comprise an internal RAM, an internal ROM, a cache memory, and/or other internal non-transitory storage blocks, sections, or components that may be referred to in some contexts as non-transitory computer readable media or computer readable storage media.

The ordering of steps in the various processes, data flows, and flowcharts presented are for illustration purposes and do not necessarily reflect the order that various steps must be performed. The steps may be rearranged in different orders in different embodiments to reflect the needs, desires and preferences of the entity implementing the systems. Furthermore, many steps may be performed simultaneously with other steps in some embodiments.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. A system for setting price points for a sale product, the system comprising:
a data collection server that is configured to collect data from display systems of a sale product, third party providers of the sale product, or combinations thereof, wherein the data is collected to set a price point for a product, wherein the price point is associated with the sale product, by searching related pricing for the sale product,
a middleware server that is configured to analyze and sort the data to generate a visualization of the data,
a model server that is configured to tune the visualization of the data and reduce artificial intelligence hallucinations occurring in the visualization of the data, and
a display platform to display the visualization of the data, wherein the display platform displays the price point for the product based on the data.

2. The system of claim 1, wherein the data collection server collects the data based on deal rankings assigned by the display systems which display the sale product.

3. The system of claim 1, wherein the middleware server gathers historical price movements of the sale product as dictated by past market conditions.

4. The system of claim 3, wherein the middleware server determines current market conditions for the sale product.

5. The system of claim 4, wherein the middleware server projects expected future price movements for the sale product based on the current market conditions.

6. The system of claim 5, wherein the middleware server projects future buyer interest in the sale product based on the current market conditions.

7. The system of claim 1, wherein the visualization of the data illustrates past, present, future projected price points for the product, or combinations thereof.

8. The system of claim 7, wherein the visualization of data illustrates changes in a price associated with the sale product.

9. The system of claim 1, wherein the sale product is an individual product.

10. The system of claim 1, wherein the sale product is the product.

11. The system of claim 10, wherein the product is a vehicle.

12. The system of claim 1, wherein the sale product is a class of products.

13. The system of claim 12, wherein the product is a member of the class of products.

14. The system of claim 13, wherein the product is a vehicle.

15. A method for setting price points for a sale product, the method comprising:
collecting data from display systems of a sale product, third party providers of the sale product, or combinations thereof, with a data collection server, wherein the data is collected to set a price point for a product, wherein the price point is associated with the sale product, by searching related pricing for the sale product,
analyzing and sorting the data to generate a visualization of the data with a middleware server,
tuning the visualization of the data and reducing artificial intelligence hallucinations occurring in the visualization of the data with a model server, and
displaying the visualization of the data on a display platform, wherein the display platform displays the price point for the product based on the data.

16. The method of claim 15, further comprising collecting the data based on deal rankings assigned by the display systems which display the sale product.

17. The method of claim 15, further comprising gathering historical price movements of the sale product as dictated by past market conditions.

18. The method of claim 15, further comprising:
determining current market conditions for the sale product,
projecting expected future price movements for the sale product based on the current market conditions, and
projecting future buyer interest in the sale product based on the current market conditions.

19. The method of claim 15, further comprising illustrating past, present, future projected price points for the product, or combinations thereof.

20. The method of claim 19, further comprising illustrating changes in the price of the sale product.
